(19) United States
(12) Patent Application Publication
(10) Pub. No.: US 2024/0359711 A1
(43) Pub. Date: Oct. 31, 2024

(54) SYSTEM AND METHOD OF TRANSITIONING VEHICLE CONTROL

(71) Applicant: NISSAN NORTH AMERICA, INC., Franklin, TN (US)

(72) Inventors: Erik ST. GRAY, Tacoma, WA (US); Stefan WITWICKI, San Carlos, CA (US)

(21) Appl. No.: 18/308,627

(22) Filed: Apr. 27, 2023

(51) Int. Cl. B60W 60/00; B60W 50/14

(52) U.S. Cl. CPC B60W 60/0053; B60W 50/14; B60W 2050/146; B60W 2420/403; B60W 2540/229

(57) ABSTRACT

A system and method of transitioning control of a vehicle from an autonomous control state to a manual control state is provided. A transition point is determined at which control of the vehicle changes from the autonomous control state to the manual control state. At least one task is presented to a driver in advance of the transition point. Whether the response of the driver to the at least one task indicates preparedness of the driver is determined. Control of the vehicle is transitioned from the autonomous control state to the manual control state when the driver is determined to be prepared. The transition from the autonomous control state to the manual control state is prevented when the driver is determined to not be prepared.

### BACKGROUND

### Technical Field

The present disclosure generally relates to a system and method of transitioning vehicle control. More specifically, the present disclosure relates to a system and method of transitioning vehicle control from an autonomous control state to a manual control state.

### Background Information

Autonomous driving systems require varying degrees of driver attentiveness depending on the level of driving automation. The Society of Automotive Engineers (SAE) defines six levels of driving automation from Level 0 (no driving automation) to Level 5 (full driving automation) in the SAE J3016 standard. Due to the lack of complete attention provided by a driver based on the level of driving automation under which the vehicle is currently operating, existing vehicle control systems provide visual and audio warnings to alert the driver when transitioning from an autonomous control mode to a manual control mode. Some of these existing systems include a timer that counts down to when the driver assumes manual control of the vehicle.

### SUMMARY

An object of the present disclosure is to provide a system and method of transitioning vehicle control from an autonomous control state to a manual control state.

In view of the state of the known technology, one aspect of the present disclosure is to provide a method of transitioning control of a vehicle from an autonomous control state to a manual control state. A transition point is determined at which control of the vehicle changes from the autonomous control state to the manual control state. At least one task is presented to a driver in advance of the transition point. Whether the response of the driver to the at least one task indicates preparedness of the driver is determined. Control of the vehicle is transitioned from the autonomous control state to the manual control state when the driver is determined to be prepared. The transition from the autonomous control state to the manual control state is prevented when the driver is determined to not be prepared.

Another aspect of the present disclosure is to provide a vehicle transition control system to control transition of a vehicle from an autonomous control state to a manual control state. The control system includes an on-board satellite navigation system in communication with a global positioning system, an on-board sensor network configured to monitor conditions internally and externally of the vehicle, a display device, and a processor. The processor is configured to determine a transition point at which control of the vehicle changes from the autonomous control state to the manual control state, present at least one task to a driver in advance of the transition point through the display device based on information obtained by the on-board satellite navigation system and the on-board sensor network, determine whether the response of the driver to the at least one task indicates preparedness of the driver, transition control of the vehicle from the autonomous control state to the manual control state when the driver is determined to be prepared, and prevent the transition from the autonomous control state to the manual control state when the driver is determined to not be prepared.

Also other objects, features, aspects and advantages of the disclosed system and method of transitioning vehicle control will become apparent to those skilled in the art from the following detailed description, which, taken in conjunction with the annexed drawings, discloses exemplary embodiments of the system and method of transitioning vehicle control.

### BRIEF DESCRIPTION OF THE DRAWINGS

Referring now to the attached drawings which form a part of this original disclosure:

FIG. 1 is a schematic illustration of a vehicle equipped with a vehicle transition control system;

FIG. 2 is a schematic illustration of the components of the vehicle transition control system:

FIG. 3 is a schematic illustration of the vehicle in communication with a GPS server, a cloud server and a vehicle network;

FIG. 4 is a schematic illustration of a control transition period from an autonomous control state to a manual control state:

FIG. 5 is a schematic illustration of components of a vehicle transition control system to control the transition from the autonomous control state to the manual control state:

FIG. 6 is a schematic illustration of a first example of a transition point of the vehicle transition control system:

FIG. 7 is a schematic illustration of a second example of a transition point of the vehicle control system:

FIG. 8 is a schematic illustration of a control transition period with reference to a navigation route of a vehicle:

FIG. 9 is a schematic illustration of a first task presented to a driver through a display device:

FIG. 10 is a schematic illustration of a second task presented to a driver;

FIG. 11 is a schematic illustration of a third task presented to a driver:

FIG. 12 is a schematic illustration of a control transition period; and

FIG. 13 is a flowchart of a method of transitioning control from the autonomous control state to the manual control state.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

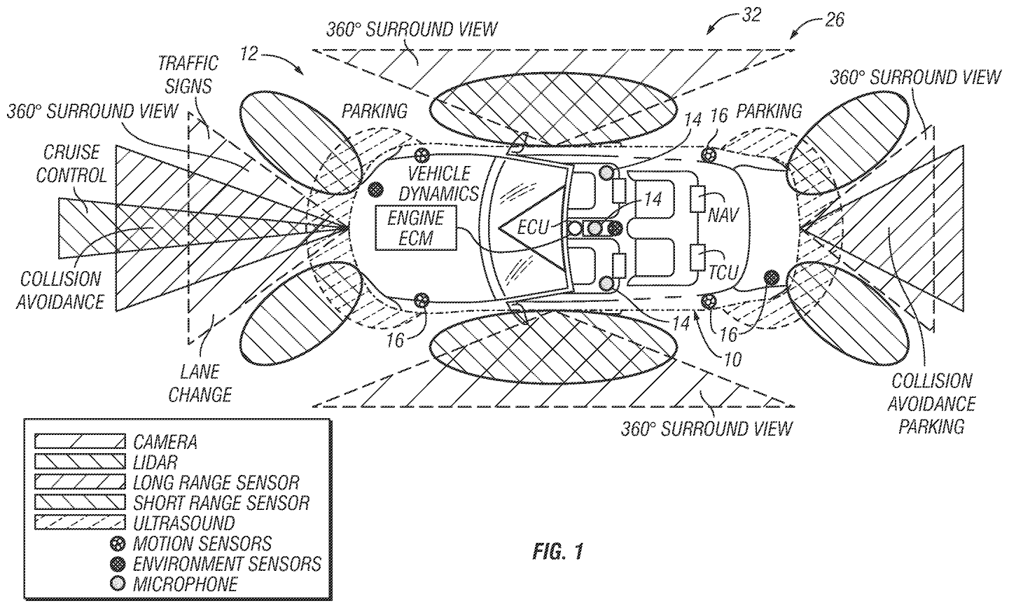

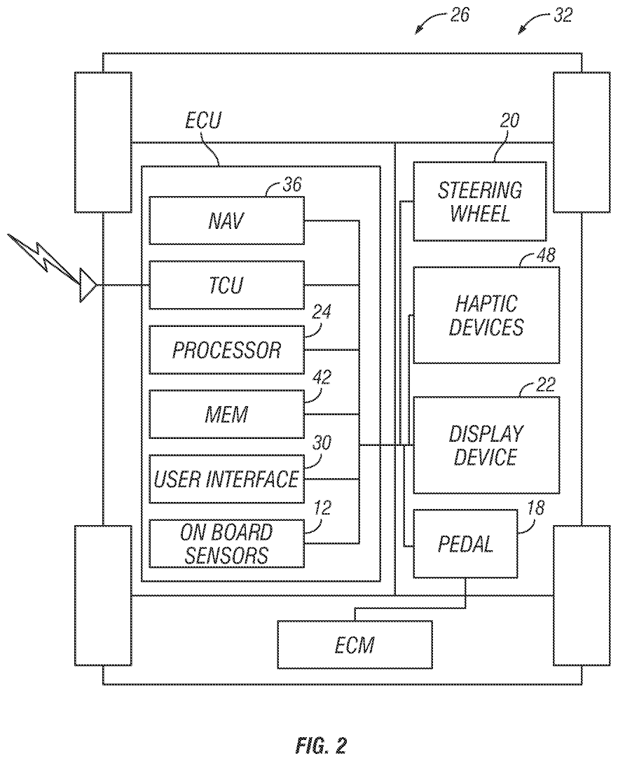

Referring initially to FIG. 1, a vehicle 10 is schematically illustrated as being equipped with a plurality of control modules for navigation assistance. In the illustrated embodiment, the vehicle 10 is equipped with an on-board satellite navigation device NAV 36 and a telematics control unit TCU, as best seen in FIGS. 1 and 2. The on-board satellite navigation device NAV and a telematics control unit TCU are considered examples of control modules for navigation assistance. The vehicle 10 is further equipped with an on-board sensor network 12 that monitors both internal and external conditions of the vehicle 10. That is, the on-board sensor network 12 includes internal sensors 14 to monitor conditions regarding the interior of the vehicle 10, such as the passenger compartment of the vehicle.

The on-board sensor network 12 further includes environmental sensors 16 that monitor conditions regarding the exterior vicinity of the vehicle 10. For example, the vehicle 10 can be equipped with one or more unidirectional or omnidirectional external cameras that take moving or still images of the vehicle surroundings. In addition, the external cameras can be capable of detecting the speed, direction, yaw, acceleration and distance of the vehicle 10 relative to a remote object. The environmental sensors 16 can also include infrared detectors, ultrasonic detectors, radar detectors, photoelectric detectors, magnetic detectors, acceleration detectors, acoustic/sonic detectors, gyroscopes, lasers or any combination thereof. The environmental sensors 16 can also include object-locating sensing devices including range detectors, such as FM-CW (Frequency Modulated Continuous Wave) radars, pulse and FSK (Frequency Shift Keying) radars, sonar and Lidar (Light Detection and ranging) devices. The data from the environmental sensors 16 can be used to determine information about the vicinity of the vehicle 10, as will be further described below. The sensor network further includes vehicle a speed sensor and a torque sensor to detect a navigation state of the vehicle 10.

Preferably, the internal sensors 14 include at least one internal unidirectional or omnidirectional camera positioned to detect behavior of one or more passengers in the passenger compartment. The internal sensors 14 further include at least one internal microphone positioned to detect behavior of one or more passengers in the passenger compartment. The internal sensors 14 are provided to detect the behavior of the driver and/or passenger(s) of the vehicle 10. For example, the internal sensors 14 can detect a state of whether the driver is distracted, unfocused or unresponsive. Cameras and microphones can detect whether the driver is engaged with a conversation with another passenger and is not paying attention to the navigation system or road conditions.

As shown in FIG. 2, the vehicle 10 is further equipped with a user operation device for controlling an operation of the vehicle 10. In the illustrated embodiment, the term user operation device for the vehicle 10 includes any device used for controlling the behavior of the vehicle 10 regarding torque, speed, direction, acceleration or deceleration. In the illustrated embodiment, user operation device includes a vehicle pedal 18. The user operation device further includes a steering wheel 20. Therefore, the vehicle 10 further includes the vehicle pedal 18 and the steering wheel 20. The user operation devices listed are included as examples only. It will be apparent to those skilled in the vehicle field from this disclosure that the vehicle 10 can include additional or alternative user operation devices as needed and/or necessary.

As shown in FIG. 2, the vehicle 10 is further equipped with an electronic display device 22 configured to display notification data to the driver. The electronic display device 22 is positioned in an interior, or passenger, compartment of the vehicle 10. The vehicle 10 is further equipped with an electronic control unit (ECU) controlling the electronic display device 22 to display notification data based on information received by the on-board sensor network 12, as will be further described. In particular, the ECU includes a processor 24 for controlling the operation of a notification system 26 of the vehicle 10, as will be further described. In the illustrated embodiment, the display device 22 is provided as part of the notification system 26 for the vehicle 10.

In the illustrated embodiment, notification data can include warnings, alerts, recommended maneuvers, road information, etc. In the illustrated embodiment, the processor 24 is programmed to control the electronic display device 22 to display the notification data. In particular, the processor 24 is programmed to control the electronic display device 22 to display notification data regarding the condition of the vicinity of the vehicle based on one or more of the real-time information, the crowdsourced information and the predetermined information, as will be further described below.

In the illustrated embodiment, the vicinity of the vehicle refers to an area within approximately a two hundred meter distance to approximately a one mile distance of the vehicle 10 from all directions. The vicinity of the vehicle includes an area that is upcoming on the navigation course of the vehicle 10.

Referring to FIGS. 1 and 2, the vehicle's 10 control modules for navigation assistance will now be further discussed. In particular, the on-board satellite navigation device NAV is in communication with a global positioning system unit (GPS) to acquire real-time information regarding conditions near the vicinity of the vehicle 10. The on-board satellite navigation device NAV can be a global navigation satellite system (GNSS) receiver or GPS receiver that is capable of receiving information from GNSS satellites then calculate the device's geographical position. Therefore, the on-board satellite navigation device NAV acquires GPS information for the vehicle 10.

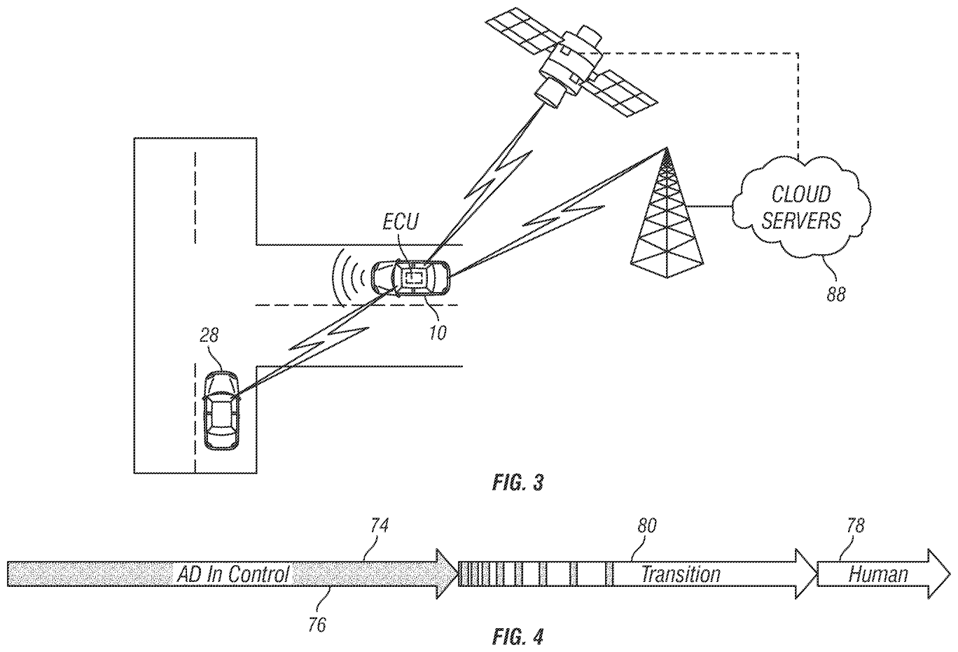

As shown in FIG. 3, the on-board satellite navigation device NAV can also be in communication with a Wide Area Augmentation System (WAAS) enabled National Marine-Electronics Association (NMEA) unit, a radio triangulation unit, or a combination thereof. The on-board satellite navigation device NAV can obtain information that represents, for example, a current heading of the vehicle 10, a current position of the vehicle 10 in two or three dimensions, a current angular orientation of the vehicle 10, or a combination thereof. In this way, the on-board satellite navigation device NAV captures real-time information regarding conditions regarding the vicinity of the vehicle 10.

As shown in FIGS. 2 and 3, the telematics control unit TCU is in wireless communication to at least one of a cloud server 88 and a vehicle network to upload and receive crowdsourced information regarding conditions near the vicinity of the vehicle 10. The TCU receives the crowdsourced information that is preferably automatically stored in the non-transitory computer readable medium MEM, as will be further described. Data from on-board electronic control units ECUs and the on-board sensors can also be transmitted by the TCU to the cloud server 88 or to the vehicle network. That is, the location of the vehicle 10, the method of traversal and own experience on a navigation path can also be transmitted to the cloud server or the cloud network.

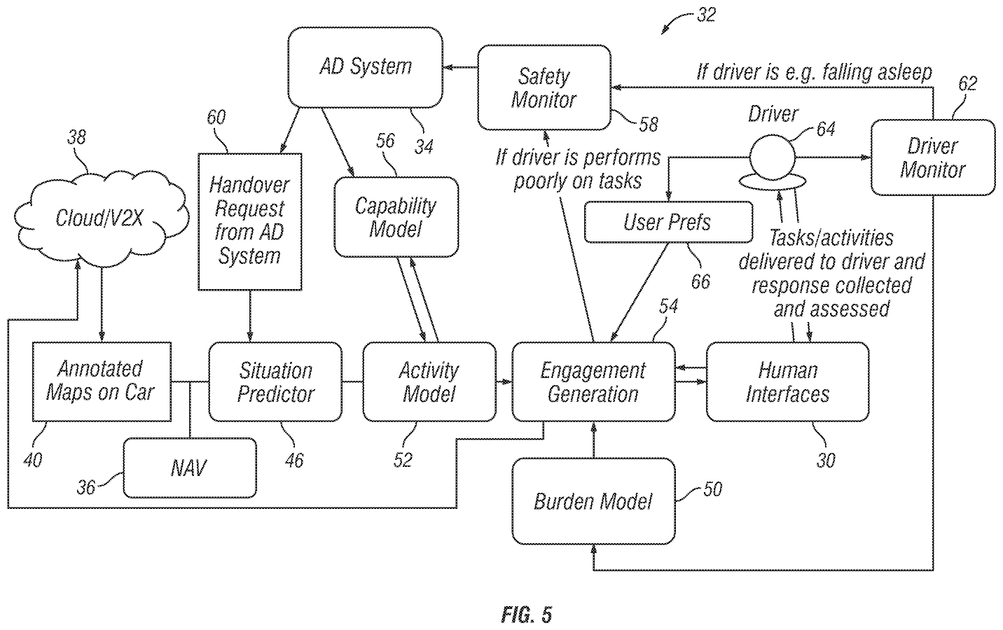

The TCU is an embedded computer system that wirelessly connects the vehicle 10 to cloud services or other vehicle networks via vehicle-to-everything (V2X standards) over a cellular network, as shown in FIGS. 2 and 3. The cloud/V2X infrastructure 38, as shown in FIGS. 2 and 5, provides data about traffic and the environment of the vehicle 10. The TCU collects telemetry data regarding the vehicle 10, such as position, speed, engine data, connectivity quality, etc. by interfacing with various sub-systems and control busses in the vehicle 10. The TCU can also provide in-vehicle 10 connectivity via Wi-Fi and Bluetooth. The TCU can include an electronic processing unit, a microcontroller, a microprocessor, or a field programmable gate array (FPGA), which processes information and serves to interface with the GPS unit. The TCU can further include a mobile communication unit and memory for saving GPS values in case of mobile-free zones or to intelligently store information about the sensor data of the vehicle 10. The memory that stores the information from the TCU can either be part of the TCU or the on-board ECU of the vehicle 10.

Using the TCU, the vehicle 10 can communicate with one or more other vehicles 28 (e.g., the vehicle network), as shown in FIG. 3. For example, the TCU is capable of receiving one or more automated inter-vehicle messages, such as a basic safety message (BSM), from a remote vehicle 28 via a network communicated using the TCU. Alternatively, the TCU can receive messages via a third party, such as a signal repeater (not shown) or another remote vehicle 28. The TCU can receive one or more automated inter-vehicle messages periodically, based on, for example, a defined interval, such as 100 milliseconds.

Automated inter-vehicle messages received and/or transmitted by the TCU can include vehicle identification information, geospatial state information (e.g., longitude, latitude, or elevation information, geospatial location accuracy information), kinematic state information (e.g., vehicle acceleration information, yaw rate information, speed information, vehicle heading information, braking system status information, throttle information, steering wheel angle information), vehicle routing information, vehicle operating state information (e.g., vehicle size information, headlight state information, turn signal information, wiper status information, transmission information) or any other information, or combination of information, relevant to the transmitting vehicle state. For example, transmission state information may indicate whether the transmission of the transmitting vehicle 10 is in a neutral state, a parked state, a forward state, or a reverse state.

The TCU can also communicate with the vehicle network via an access point. The access point can be a base station, a base transceiver station (BTS), a Node-B, an enhanced Node-B (eNode-B), a Home Node-B (HNode-B), a wireless router, a wired router, a hub, a relay, a switch, or any similar wired or wireless device. The vehicle 10 can communicate with the vehicle network via the NAV or the TCU. In other words, the TCU can be in communication via any wireless communication network such as a high bandwidth GPRS/IXRTT channel, a wide area network (WAN) or a local area network (LAN), or any cloud-based communication, for example. Therefore, using the TCU, the vehicle 10 can participate in a computing network or a cloud-based platform.

The cloud server and/or the vehicle network can provide the vehicle 10 with information that is crowdsourced from drivers, pedestrians, residents and others. For example, the cloud server and/or the vehicle network can inform the vehicle 10 of a live concert with potential for large crowds and traffic congestion along the path on or near the travel route of the vehicle 10. The cloud server and/or the vehicle network can also inform the vehicle 10 of potential pedestrians along the path on or near the travel route of the vehicle 10, such as children getting off from school based on a location of a school with respect to the navigation path of the vehicle 10 and the current time. The cloud server and/or the vehicle network can also inform the vehicle 10 of conditions of general oncoming traffic, oncoming signs and lights, incoming lanes, restricted lanes, road closures, construction sites, potential vehicle encounters, accidents, and potential pedestrian encounters, etc.

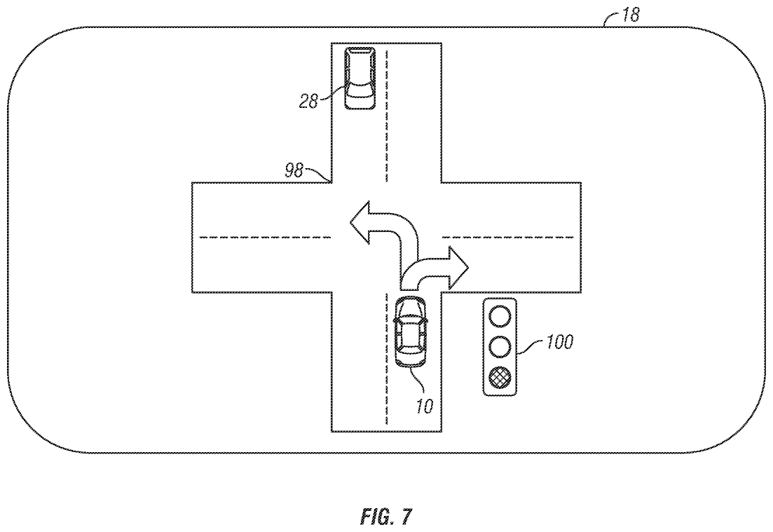

The crowdsourced information obtained from the cloud server and/or the vehicle network can also include intersection geometry tags for locations pre-identified or computed to be difficult or poor visibility at junctions (based on geometric calculations, or crowdsourced data from other vehicles 28). This type of information can be displayed as notification data on the display device 22, as shown in FIG. 7.

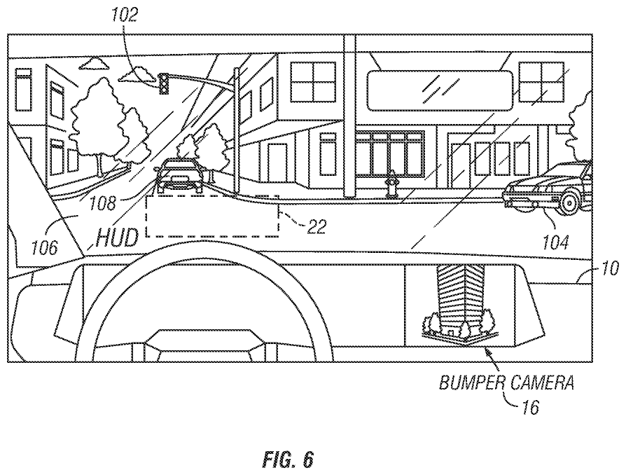

The TCU can also inform the vehicle 10 of information received from a transportation network and/or a pedestrian network to receive information about pedestrian navigable area, such as a pedestrian walkway or a sidewalk, may correspond with a non-navigable area of a vehicle transportation network. This type of information can be displayed as notification data on the device 22, as shown in FIG. 6.

The vehicle network can include the one or more transportation networks that provides information regarding unnavigable areas, such as a building, one or more partially navigable areas, such as parking area, one or more navigable areas, such as roads, or a combination thereof. The vehicle transportation network may include one or more interchanges between one or more navigable, or partially navigable, areas.

The vehicle 10 further comprises the on-board electronic control unit ECU, as shown in FIG. 2. The vehicle 10 can include more than one on-board ECU for controlling different systems of the vehicle 10, such as the vehicle notification system 26 and a vehicle transition control system 32, although one is illustrated and described for simplicity. The ECU has a non-transitory computer readable medium MEM. The ECU further includes a processor 24 with a microprocessor programmed to perform control functions that will be further discussed below. The non-transitory computer medium preferably stores information, such as navigation maps or road condition maps, on the vehicle 10 for at least a period of time.

This information can be downloaded from the cloud server 88 and/or the vehicle network server monthly, weekly, daily, or even multiple times in a drive, and is preferably stored locally for processing by the driver support system. Therefore, the non-transitory computer readable medium MEM preferably stores regularly updated maps with information about activities that can be encountered by the vehicle 10, such as neighborhood information. The non-transitory computer medium preferably stores information that are downloaded from the cloud server and/or the vehicle network. This information is in conjunction with the real-time information acquired by the NAV (e.g., the GPS data). The processor 24 controls automatic download of information from the cloud server and/or the vehicle network at regular intervals.

In the illustrated embodiment, the non-transitory computer readable medium MEM stores predetermined information regarding conditions near the vehicle's 10 vicinity. In particular, the non-transitory computer readable medium MEM stores predetermined threshold information for displaying notification data to the user, as will be further described below. The predetermined information can also include a database of road or navigation conditions, as will be further described below. The processor 24 controls the display device 22 to display notification information based on information acquired by all the systems and components described above.

As shown in FIGS. 2 and 6, the electronic display device 22 is provided in the vehicle 10 interior. The display device 22 is in connection with the ECU to receive control information from the ECU. The display device 22 can include a single type display, or multiple display types (e.g., both audio and visual) configured for human-machine interaction. The display device 22 include any type of display panel as desired to display notification data, navigation data and other information.

Therefore, the display device 22 can be one or more dashboard panels configured to display lights, text, images or icons. Alternatively, the display device 22 can include a heads-up display, as shown in FIG. 6. Thus, the display device 22 can be directly mounted onto the vehicle body structure, or mounted onto the window panels. Alternatively, the display device 22 can be provided on a mobile device that is synced with the ECU of the vehicle 10. The display device 22 can have different shapes and sizes to accommodate the shape and contours of the vehicle 10.

As shown in FIG. 2, the display device 22 further includes a set of user input interfaces 30 to communicate with the driver. The display device 22 is configured to receive user inputs from the vehicle occupants. The display device 22 can include, for example, control buttons and/or control buttons displayed on a touchscreen display (e.g., hard buttons and/or soft buttons) which enable the user to enter commands and information for use by the ECU to control various aspects of the vehicle 10. For example, input interface 30 provided to the display device 22 can be used by the ECU to monitor the climate in the vehicle 10, interact with the navigation system, interact with the vehicle transition control system 32, control media play back, or the like. The display device 22 can also include a microphone that enables the user to enter commands or other information vocally or audibly. The display device 22 can further include one or more speakers that provide sound alerts and sound effects including computer-generated speech.

The display device 22 is part of the vehicle notification system 26 and the vehicle transition control system 32, as illustrated in FIGS. 1 and 2. In the illustrated embodiment, the notification system 26 and the vehicle transition control system 32 include the electronic display device 22 configured to be displayed in an interior compartment of the vehicle 10. The notification system 26 and the vehicle transition control system 32 further includes the electronic control unit ECU having the processor 24 and the non-transitory computer readable medium MEM storing predetermined information regarding conditions near the vicinity of the vehicle. With the notification system 26 and the vehicle transition control system 32, the processor 24 is programmed to control the electronic display device 22 to display notification data regarding the vicinity of the vehicle based on the predetermined information that is stored in the non-transitory computer readable medium MEM.

The notification system 26 and the vehicle transition control system 32 further include the NAV that acquires information from the GPS unit and the TCU acquiring information from the cloud server and the vehicle network. In the illustrated embodiment, the processor 24 is programmed to automatically download information from the cloud services and the vehicle network to be stored in the non-transitory computer readable medium MEM (daily, weekly, upon vehicle ignition turning ON). This allows for the technical improvement of the vehicle 10 having the notification system 26 and the vehicle transition control system 32 to not need to be connected to the cloud server 88 or the vehicle network in real-time in order to be able to display information based on information received from the cloud server or the vehicle network.

The user can input preferences for the notification system 26 and the vehicle transition control system 32 into the user interface 30. For example, the user can activate/deactivate the notification system 26 using the user interface 30. The user can also select between versions or modes of the notification system 26 and the vehicle transition control system 32, such as selecting icon preferences (e.g., size or location), display preferences (e.g., frequency of display, map based, icon based, etc.), sound OFF or sound only.

The notification system 26 is provided to help inform drivers of oncoming road conditions and conditions regarding the vicinity of the vehicle 10 to help the driver make better driving decisions. Preferably, the notification system 26 of the illustrated embodiment enables the display device 22 to display information that is predictive of upcoming driving conditions. By utilizing information received by the TCU and NAV on a continuous basis, while also downloading conditions onto the on-board computer readable medium MEM for at least a period of time, the notification system 26 of the vehicle 10 can be utilized as a low-cost application with limited need for continuous real-time sensing or detector use. This arrangement enables the technical improvement of allowing the on-board sensor network 12 to be utilized for a burden model of the notification system 26 to determine a burden state of the driver and/or passengers and control the display device 22 to display notification data accordingly.

In the illustrated embodiment, the notification system 26 and the vehicle transition control system 32 are controlled by the processor 24. The processor 24 can include any device or combination of devices capable of manipulating or processing a signal or other information now-existing or hereafter developed, including optical processors, quantum processors, molecular processors, or a combination thereof. For example, the processor 24 can include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. As shown in FIG. 2, the processor 24 is operatively coupled with the computer readable medium MEM, the input user interface 30, the sensor network 12, the TCU, the NAV and the display device 22.

As used herein, the terminology processor 24 indicates one or more processors, such as one or more special purpose processors, one or more digital signal processors, one or more microprocessors, one or more controllers, one or more microcontrollers, one or more application processors, one or more Application Specific Integrated Circuits, one or more Application Specific Standard Products: one or more Field Programmable Gate Arrays, any other type or combination of integrated circuits, one or more state machines, or any combination thereof.

As used herein, the terminology memory or computer-readable medium MEM (also referred to as a processor-readable medium MEM) indicates any computer-usable or computer-readable medium MEM or device that can tangibly contain, store, communicate, or transport any signal or information that may be used by or in connection with any processor. For example, the computer readable medium MEM may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

Therefore, the computer-readable medium MEM further includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media can include, for example, optical or magnetic disks and other persistent memory. Volatile media may include, for example, dynamic random access memory (DRAM), which typically constitutes a main memory.

The computer readable medium MEM can also be provided in the form of one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The processor 24 can execute instructions transmitted by one or more transmission media, including coaxial cables, copper wire and fiber optics, including the wires that comprise a system bus coupled to a processor of a computer. As used herein, the terminology instructions may include directions or expressions for performing any method, or any portion or portions thereof, disclosed herein, and may be realized in hardware, software, or any combination thereof.

For example, instructions may be implemented as information, such as a computer program, stored in memory that may be executed by the processor 24 to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

Computer-executable instructions can be compiled or interpreted from computer programs created using a variety of programming languages and/or technologies, including, without limitation, and either alone or in combination, Java™, C, C++, Visual Basic, Java Script, Perl, etc. In general, the processor 24 receives instructions from the computer-readable medium MEM and executes these instructions, thereby performing one or more processes, including one or more of the processes described herein. Such instructions and other data may be stored and transmitted using a variety of computer-readable media.

For example, the processor 24 can also use information from the environmental sensors 16 to identify, the type of road (e.g., type of lanes and lane segments, urban or highway), difficulty of traversal of lane(s) and lane segment(s), density of traffic, the level of the density, etc.

In the illustrated embodiment, the processor 24 is programmed to anticipate information regarding upcoming conditions near the vicinity of the vehicle 10 based on one or more of the real-time information received from the on-board satellite navigation device NAV, the crowdsourced information and the predetermined information (stored in the computer readable medium MEM). The processor 24 is programmed to predict and anticipate oncoming road conditions within the vicinity of the vehicle 10 based on the real-time information received from the on-board satellite navigation device NAV, the crowdsourced information, and the predetermined information.

Preferably, the processor 24 can anticipate or predict oncoming road conditions by also calculating geometric arrangements of road conditions based on the real-time information, the crowdsourced information and the predetermined information, as will be described, as will be further described below. In this way, the processor 24 can determine occlusions and display them on the display device 22, such as shown in FIG. 7. Therefore, the display device 22 can display notification data including upcoming conditions near the vicinity of the vehicle that is anticipated by the processor 24.

As stated, the non-transitory computer readable medium MEM stores predetermined information. For example, the non-transitory computer readable medium MEM includes one or more database of road conditions or situations. The database can include a set of road feature parameters that can be applicable for almost all navigation paths along a road feature or intersection (e.g., intersection type, ongoing traffic control(s), lane types and numbers, lane angles, etc.). The database can optionally further include a set of path parameters (e.g., straight, left turn, right turn, U-turn, etc.) for the notification system 26 and the vehicle transition control system 32. That is, the computer readable medium MEM stores a database of driving scenarios that can be compared with the real time driving scenario of the vehicle 10 in order to inform the notification system 26 and the vehicle transition control system 32 of appropriate notification data to display on the display device 22.

For example, if the driver intends to make a right turn at a red light, the notification system 26 can display notification data that a light is upcoming on the display device 22, as shown in FIG. 7. In addition, the notification can optionally display additional feedback about whether a right turn is legal or not legal at that intersection on the display device 22. The computer readable medium MEM can also include the situation of a left turn at an upcoming traffic light that is red. The display device 22 can inform the driver that a stop event is necessary due to the traffic light or due to another vehicle 28 having the right of way. Therefore, the display device 22 can display upcoming conditions including at least one of a vehicle stopping event, a vehicle deceleration event, a vehicle acceleration event and a lane change event.

In another example, if the driver is turning left at an upcoming T-junction where the driver is on the main road, the notification system 26 can notify the driver that oncoming traffic will not stop for them. The notification can be based on the information prestored in the computer readable medium MEM that can include crowdsourced information from the cloud services and the vehicle network, and be based on the real-time GPS information that is detecting where the driver is going.

In these examples, the processor 24 can determine the navigation path of the vehicle 10 based on information received from the NAV and the on-board sensor network 12 that monitors real-time vehicle activity. The processor 24 is programmed to anticipate upcoming situations that can be encountered by the vehicle 10 based on the direction of travel, time, speed, etc. of the vehicle 10. The processor 24 is further programmed to compare the upcoming situations that are anticipated with the database of situations that are stored in the computer readable medium MEM. When there is a match, the processor 24 controls the electronic display device 22 to display the appropriate notification.

The notification data that is displayed can include notification of an upcoming scenario type, and/or a predicted estimated time to arrival (ETA). In another example, if the driver is driving with the NAV OFF and the processor 24 cannot determine where the driver is going, the processor 24 can be programmed to assume that the driver will go straight as a default setting in the event that the processor 24 has not determined that the vehicle 10 is changing lanes. Alternatively, the processor 24 can determine certain vehicle maneuvers, such as left or right turn, lane change, by detecting that the turn signal of the vehicle 10 is ON, or by detecting a torque output or a steering wheel maneuver. In this instance, the processor 24 can control the display device 22 accordingly upon determining these vehicle maneuvers. Therefore, it will be apparent to those skilled in the vehicle field from this disclosure that the ECU can be connected to various control systems and control modules of the vehicle (such as the engine control module, etc.) to determine the vehicle condition, etc.

The display device 22 can display notification data for intersection type assistance. For example, the notification data displayed by the display device 26 can include an identification of the intersection type, as shown in FIG. 6, and also whether the intersection is traffic controlled. The notification data can also be displayed for intersection priority assistance at a multi-way stop. The display device 22 can provide notification as to whether another vehicle 28 has the right of way and which order to proceed towards the intersection.

The display device 22 can also provide notification data that provides options for maneuvers. For example, at a traffic light turn, the display device 22 can display options for which maneuvers are allowed and which maneuvers are prohibited. The display device 22 can further display icons, graphics or instructions indicating crucial areas of interest to direct the driver's focus. For example, the display device 22 is a heads up display on the windshield, as shown in FIG. 6. Optionally, the display device 22 can display arrows pointing to areas of interest where the driver should pay attention (e.g., junctions at an acute or obtuse angle instead of at right angles, bicycle lanes, pedestrian lanes, etc.).

The display device 22 can also display notification data that provide notification data informing the driver oncoming short merges based on the GPS data, the navigation path and speed of the vehicle. The display device 22 can also display notification data that provide notification data informing the driver about restricted lanes (including bus lanes, sidewalks, trolley tracks) that might appear road-like. The display device 22 can also display notification data that provide notification data informing the driver about areas of restricted visibility that are upcoming and require special techniques. Therefore, the display device 22 can display notification data including upcoming occlusions in which the driver might not be able to see a road sign or a portion of a crosswalk, intersection, etc.

The display device 22 can also display notification data that provide notification data informing the driver about pinch points where road space is reduced to the point that negotiation with other vehicles may be necessary to proceed with more caution. The display device 22 can also display notification data that provide notification data informing the driver about upcoming mid-block pedestrian crossings.

The display device 22 can also display notification data that provide notification informing the driver of rapid sequence of upcoming decisions in succession. For example, the notification data can provide recommendations or alerts for an upcoming series of junctions that will occur in short succession. Therefore, the display device 22 can display upcoming conditions including a series of events occurring in succession. The series of events that can occur in succession includes at least a vehicle stopping event, a vehicle deceleration event, a vehicle acceleration event (vehicle needs to accelerate to make an exit) and a lane change event.

The notification system 26 and the vehicle transition control system 32 can include a human burden module 50, as shown in FIG. 5, that determines a burden condition of the driver. The display device 22 can display notification data that accounts for the burden condition of the driver and/or any of the passengers. As previously stated, the internal sensors 14 (e.g., microphones and cameras) are positioned to detect behavior of one or more passengers in the passenger compartment (e.g., whether the driver is distracted, unfocused or unresponsive).

The internal sensors 14 can detect whether the driver is distracted by another task, such as holding a mobile device or talking to someone. The internal sensors 14 can detect whether the driver is focused or looking at the road ahead or whether they are focused on other subjects. The processor 24 can then assess whether the driver is likely to become overburdened based in information detected by the internal sensors 14, such as detecting that the driver is glancing up and down from a map or a mobile device, detecting audible signs of confusion, sporadic acceleration and braking, etc.

In the illustrated embodiment, the processor 24 can be programmed to determine or anticipate a situation in which the driver is likely to become burdened, the degree of the burden and/or the nature of the burden based on information detected by the internal sensors 14. The processor 24 can concurrently determine the current or upcoming road condition for the vehicle 10 and determine whether the display device 22 needs to display enhanced notification or alerts so to engage the interest of the driver. Therefore, the processor 24 is programmed to determine a burden condition of the driver of the vehicle 10 based on information received from the on-board sensor network 12.

The processor 24 can assess the degree or intensity of the burden condition of the driver based on one or more of the following factors or categories: center awareness, peripheral awareness, weighted visual awareness, aural awareness, touch awareness, soft support efficacy. The processor 24 can be programmed to give each of these factors a grade that can be a numerical value on a scale from zero (0) to ten (10), with zero being almost no burden and ten being very high burden. In situations of high burden (e.g., a burden grade of five to ten) the processor 24 can control the electronic display device 22 to increase the intensity of notification data that is displayed based on the conditions regarding the passenger compartment of the vehicle 10.

In this example, the burden grades of zero to ten can be examples of predetermined information that is prestored in the non-transitory computer readable medium MEM. When the processor 24 assigns a burden grade to a situation, that grade can be compared to the burden grades that are already prestored. When the assigned grades exceed a predetermined threshold, such as five or above, then the processor 24 can control the display device 22 to modify the notification or alerts as necessary. That is, the processor 24 is programmed to control the electronic display to increase the intensity of notification data that is displayed upon determining that a predetermined driver burden threshold has been met because information received from the on-board sensor network 12.

The processor 24 can also assign these factors a grade by also taking into account information detected by the NAV and the environmental sensors 16. For example, the processor 24 can heighten the grade when determining that the driver is distracted and also subject to an upcoming lane change decision. Therefore, the processor 24 can control the display device 22 to display alerts, warnings or lane change recommendations farther ahead in time of the encounter. In another example, the processor 24 can determine that the vehicle 10 is on a navigation path that will soon require a succession of lane changes in a relatively short period of time or through a short distance. Such a situation can be stressful to the driver, especially during high speed travel or high congestion. The processor 24 can control the display device 22 to display alerts, warnings, and lane change recommendations far ahead of the encounter so that the driver will anticipate the maneuver.

While the illustrated embodiment is shown as providing notification on the display device 22 having a display screen, it will be apparent to those skilled in the vehicle field from this disclosure that the notification system 26 can be applied as a haptic alert system. For example, the notification system 26 can send notification data via seat vibration, wheel vibration or accelerator pedal vibration if the processor 24 determines that a haptic alert is necessary to get the driver's attention.

As shown in FIG. 5, the vehicle 10 includes the vehicle transition control system 32 to control transitioning from an autonomous driving state to a manual driving state. The ECU, as shown in FIG. 2, includes the processor 24 for controlling the operation of vehicle transition control system 32 of the vehicle 10.

The control system includes an automated driving system 34 configured to autonomously control an operational aspect of the vehicle 10, as shown in FIG. 5. When a driver 64 of the vehicle 10 assumes manual control of the vehicle 10, the control system 32 is configured to control the transition from the autonomous driving state to the manual driving state. Assuming manual control can be based on an intent of the driver to manually control the vehicle or based on an area in which the autonomous driving state cannot operate in the current automated driving level as required.

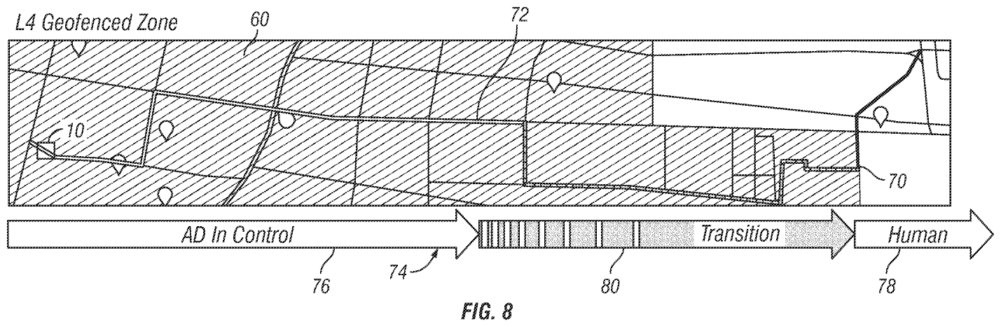

The control system 32 facilitates ensuring the driver 64 is situationally aware to assume manual control of the vehicle 10. As described below, a transition point 70 (FIG. 8) at which control of the vehicle changes from the autonomous control state 76 (FIG. 8) to the manual control state 78 (FIG. 8) is determined. At least one task is presented to the driver 64 in advance of the transition point 70. The response of the driver 64 to the at least one task determines preparedness of the driver. Control of the vehicle is transitioned from the autonomous control state 76 (FIG. 8) to the manual control state 78 (FIG. 8) when the driver 64 is determined to be prepared. Control of the vehicle from the autonomous control state 76 (FIG. 8) to the manual control state 78 (FIG. 8) is prevented when the driver 64 is determined to not be prepared.

The control system 32 is configured to facilitate increasing the situational awareness of the driver 64 when transitioning from the autonomous control state to the manual control state. The manual control state 78 (FIG. 8) can be a fully manual control state or a partially manual control state. The control system 32 is configured to identify an upcoming task or situation that is determined to be difficult for the driver, and to provide sufficient transition time in advance for the transition to the manual control state. The transition time varies based on the difficulty of the task or situation. The control system 32 is configured to transition a portion of the task and to not transition another portion of the task based on a determined difficulty for the automated driving system 34 and the driver. The task can be sequentially transitioned to the driver to gradually acclimate the driver to the manual control state. The control system 32 is further configured to monitor the burden experienced by the driver and the attentiveness of the driver during the transition period to determine the safety of the transition to the manual control state.

The control system 32 includes the on-board navigation system 36, the on-board sensor network 12, the display device 22, and the processor 24. The control system 32 further includes the cloud/V2X infrastructure 38 to provide data about the traffic and environment. The MEM 42 of the ECU includes a map module 40 storing annotated maps on the vehicle 10.

The control system 32 includes a situation prediction, or anticipation, module 46, as shown in FIG. 5. The situation prediction module 46 identifies an upcoming scenario, as described above, based on the maps stored in the map module 44 and on information from the NAV 36.

The control system 32 can include the internal sensors 14 configured to monitor the driver 64, as described above.

The control system 32 includes interfaces 30 configured to communicate with the driver, such as the display device 22, which includes speakers, a graphical display, and a heads-up display, and haptic devices 48 configured to provide touch-related feedback to the driver 64.

The control system 32 can include a burden module 50 configured to determine when the driver is over-burdened or over-loaded while operating the vehicle 10, as described above.

The control system 32 includes the user interface 30 to indicate preferences regarding how the control system 32 provides information to the driver, such as the ability of the driver 64 to manage voice and visual feedback.

The control system 32 includes a safety monitor module 50 configured to transmit a request to the automated driving system 34 to bring the vehicle to a safe stop. The safety monitor module 50 can transmit the safe stop request responsive to the driver 64 responding poorly to the at least one presented task or when a performance of the driver is determined to be unsafe, such as drifting out of a lane after transitioning to manual control, as described below.

The control system 32 includes an activity module 52, as shown in FIG. 5, configured to store activities that the driver 64 needs to accomplish to safely navigate a scenario determined by the situation prediction module 46 and a time associated with accomplishing such activities, as described below. The tasks include queries and/or tasks, or activities, presented to the driver 64.

The activity module 52 includes known tasks required to navigate a plurality of different types of roadway situations. The situation prediction module 46 sequentially outputs one or more types of upcoming situations with an amount of time to reach the upcoming situations. The activity module 52 determines tasks associated with the upcoming situations from a database of the activity module 52. The activity module 52 is configured to filter the tasks and activities by importance based on error frequency or prioritization information stored in the database, and attaches the relevant time periods to reach each activity. The generated listed of activities and time periods is transmitted to an engagement generation module 54.

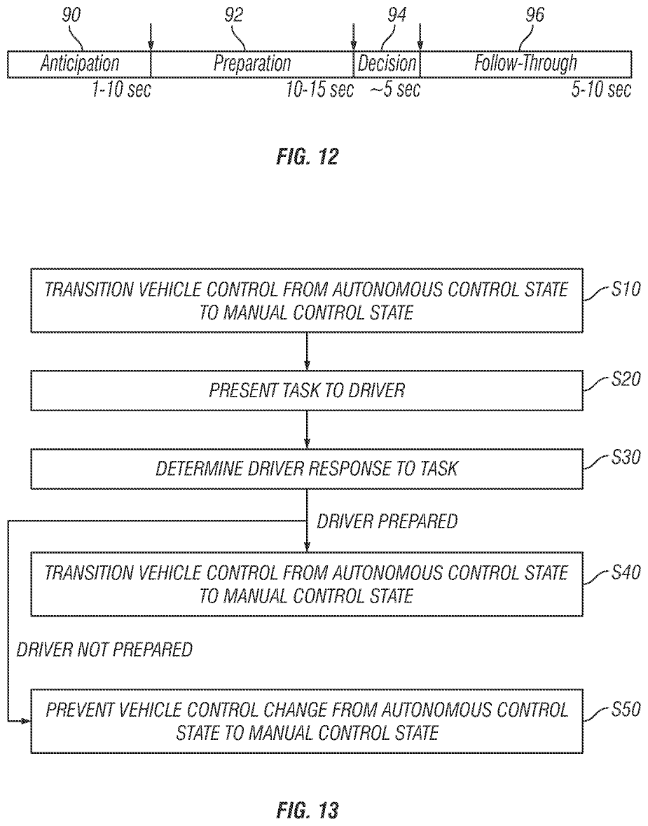

The tasks are broken down into four phases, with each phase having an associated time period. The length of each phase varies with the type of situation. The four phases are an anticipation phase, a preparation phase, a decision phase, and a follow-through phase, as shown in FIG. 12. For example, when the vehicle 10 is approaching an intersection, the anticipation phase 90 has an associated time period of 1-10 seconds. During the anticipation phase 90, the driver considers when the next action is and what needs to be done before then, such as identifying whether and where to stop and whether traffic is ahead. The preparation phase 92 has an associated time of 10-15 seconds. During the preparation phase 92, the driver considers the configurations of the lane and traffic situation, such as identifying the type of intersection and an initial assessment of other traffic. The decision phase 94 is approximately five seconds. During the decision phase 94, the driver determines when the action can be taken, such as whether the intersection can be entered and maintaining alertness for unexpected actors. The follow-through phase 96 has an associated time period of 5-10 seconds. During the follow-through phase 96, the action, such as passing through the intersection, is completed while continuing to maintain alertness for unexpected actors. The activity module stores tasks associated with probability of errors associated for a situation for each phase. For example, an intersection can store an error of not seeing a hazard, such as a pedestrian, between the vehicle and the intersection during the anticipation phase. The task to be presented to the driver can prompt the driver to look for traffic and/or pedestrians ahead of the vehicle to facilitate avoiding the driver experiencing this error. Errors and associated tasks are stored for each of the preparation, decision and follow-through phases.

For example, when the vehicle 10 is exiting a highway and a first intersection is a multi-lane stop sign intersection in which cross-traffic has the right of way. The situation prediction module 46 determines that the vehicle has twenty seconds before arriving at the intersection. Based on stored information regarding activities and phases, the activity module 52 identifies a plurality of activities and associated timelines, such as slowing down for the exit ramp (at ten seconds), selecting the appropriate lane at exit (at twelve seconds), looking for traffic/hazards ahead (at fifteen seconds), and bringing the vehicle to a stop at the intersection (at twenty seconds). The activity module 52 prioritizes the list of activities based on stored error information. The prioritized list includes selecting the appropriate lane at exit (at twelve seconds), looking for traffic/hazards ahead (at fifteen seconds), looking for crossing pedestrians (at twenty seconds), looking for cross traffic (at twenty seconds), slowing down for the exit ramp (at ten seconds), and bringing the vehicle to a stop at the intersection (at twenty seconds). This prioritized list is transmitted to the engagement generation module 54.

The control system 32 includes the engagement generation module 54, as shown in FIG. 5, configured to present at least one task to the driver. The at least one task is based on an output of the activity module 52, user preferences input to the user interface 24, and/or a state of the driver determined by the on-board sensor network 12 and/or an output of the driver burden module 50. The engagement generation module 54 is further configured to monitor the response of the driver to the at least one task.

The engagement generation module 54 includes a database of tasks to be presented to the driver that are associated with different types of tasks, such as, but not limited to, pedestrian awareness, changing speed of the vehicle, and controlling the vehicle. The engagement generation module 54 receives the prioritized list, including the associated timelines, from the activity module 52. Based on the prioritized list received from the activity module 54, the engagement generation module 54 accesses its database to determine at least one task to be sequentially presented to the driver with required time constraints to prepare the drive for the activities under the provided time constraints. The engagement generation module 54 eliminates duplicative tasks, such as insufficient time to address both tasks. The engagement generation module 54 is configured to present the at least one task to the driver and to monitor the response provided by the driver to each task. One example of a task to be presented to the driver is to verbally answer a question that can only be answered by requiring the driver to perform a visual search. Another example of a task is to request that the driver take control of the steering wheel and control the vehicle in a specified manner. The response provided by the driver can be monitored through various interfaces, such as pressing a button on a screen of an infotainment system, a verbal response captured by a microphone of an internal sensor 14, or a vehicle control response determined through position sensors.

For example, the engagement generation module 54 receives the prioritized list from the activity module 52 including selecting an appropriate lane at exit (at twelve seconds), looking for traffic/hazards ahead (at fifteen seconds), and looking for crossing pedestrians (at twenty seconds). The engagement generation module 54 determines at least one task to be presented to the driver associated with the activities of the prioritized list. The at least one task can be a question or a task for the driver, information of which interface through which to present the question or task, a timeline to complete the task, and criteria to determine a correct or incorrect response. The activity of selecting the appropriate lane at exit can include a question for the driver regarding how many lanes are on the exit ramp or how many lanes turn right. The engagement generation module 54 determines a task for each activity.

Optionally, the activities can be augmented not just by timing, but by a cognitive step, such as perception, comprehension, prediction, decision making and action. The queries stored in the database of the engagement generation module 54 can also be augmented with this information, which allows a more precise targeting of a potential problem the driver has with the presented query.

Each task, such as a question or query, is associated with a time required to respond. A sequentially ordered set of questions can be selected by the engagement generation module 54 to address the largest number of prioritized activities received from the activity module 52 within the required time constraint. For example, for the prioritized list of activities, the tasks to be presented to the driver are how many lanes turn right, which requires ten seconds to respond, does the car in front have its turn signal on, which requires five seconds to respond, and is there a pedestrian visible at the crossing, which requires six seconds to respond. The second task requires fifteen seconds to respond, based on ten seconds for the first task and five seconds for the second task. However, the second activity from the prioritized list occurs at fifteen seconds, such that insufficient time is available to respond to both the first and second tasks. The second task is eliminated from the list to be presented to the driver. The third task requires six seconds, such that the total time required for the two tasks is sixteen seconds, which is less than the timeline for reaching the intersection at twenty seconds. The first and third tasks are presented to the driver by the engagement generation module 54. Further tasks are not presented to the driver as additional tasks would require more than the twenty second timeframe for the vehicle to reach the intersection. In other words, an amount of time for the vehicle 10 to reach the transition point 70 (FIG. 8) is determined. The at least one task presented to the driver is based on the amount of time determined to reach the transition point 70 (FIG. 8).

The tasks presented to the driver in view of the timeframe is a first query regarding how many lanes turn right, which requires ten seconds are twelve seconds are available, and a second query regarding whether a pedestrian is visible at the crossing, which requires six seconds and twenty seconds are available. The engagement generation module 54 presents these tasks to the driver in a suitable manner. The first query regarding how many lanes turns right can be presented to the driver visually on the display device 22, such as the in-vehicle infotainment system, or can be audibly presented. The driver can respond audibly through an in-vehicle microphone or can press an appropriate button on a touch screen of the display device 22. Depending on the speed and accuracy of the response provided by the driver, the engagement generation module 54 can stop presenting tasks to the driver or can continue to deliver tasks until the available time (i.e., the timeframe to the intersection) is used up. When the driver responds slowly or incorrectly to the first query, the engagement generation module 54 presents the second query when the vehicle 10 is closer to the intersection and approximately six seconds away from the intersection (i.e., the timeframe associated with the task). When the driver responds incorrectly or slowly, a safety monitor module 58 causes the vehicle to enter a minimum-risk state (i.e., a minimum risk maneuver) and to pull over with the hazard lights turned on instead of allowing the vehicle to transition from the autonomous control state to the manual control state.

The control system 32 can include a capability module 56, as shown in FIG. 5, configured to identify activities or tasks that can remain under the control of the automated driving system 34, such as transitioning to a partial autonomy state or a shared control state. The capability module 32 is configured to exclude a task to be presented to the driver that remains under control of the automated driving system 34.

The automated driving system 34 is based on the SAE J3016 levels of driving automation. The SAE J3016 levels range from Level 0 (no driving automation) to Level 5 (full driving automation) in which Level 0 includes the least amount of automated assistance and Level 5 includes the greatest amount of automated assistance. In Level 0, warnings and momentary assistance are provided to the driver, such as automatic emergency braking, blind spot warning, and lane departure warning. In Level 1, steering or brake/acceleration support is provided to the driver, such as lane centering or adaptive cruise control. In Level 2, steering and brake/acceleration support is provided to the driver, such as lane centering and adaptive cruise control at the same time. In Level 3, the vehicle is driven under limited conditions when all conditions are met, such as a traffic jam chauffeur. In Level 4, the vehicle is driven under limited conditions when all conditions are met, such as a local driverless taxi. In Level 5, the vehicle is driven in the autonomous driving state under all conditions.

Transition from the autonomous driving state to the manual driving state occurs in a plurality of different situations, in addition to when requested by the driver. For example, the vehicle 10 is currently operating in Level 2 (eyes-on, hands-off assistance) and is degrading to hands-on or Level 0/1 control. Transition can also occur when the vehicle is currently operating in Level 3 (temporary eyes-off) and is degrading to Level 2 (eyes-on) or Level 0/1 manual control. Transition can also occur when the vehicle 10 is currently operating in Level 4 (eyes-off) and is degrading to Level 3 (temporary eyes-off) or is degrading to Level 2 (eyes-on) or Level 0/1 manual control. These transitions can occur when the vehicle is exiting a Level 4 mapped highway network onto city streets where Level 4 operation is not allowed, or when the vehicle is exiting a Level 4 geofenced downtown area into suburbs where Level 4 operation is not allowed. These transitions can also occur in a traffic jam in which the vehicle is currently being operated in Level 3 traffic-jam chauffeur mode and traffic is starting to flow such that the vehicle returns to Level 2 manual driving. The transition can also occur when the vehicle is exiting a mapped highway that allows hands-off Level 2 onto an exit ramp that requires Level 2 hands-on. The transition can also occur when the vehicle 10 moves from a mapped portion of a highway that allows hands-off Level 2 operation to an unmapped portion of the highway that requires hands-on Level 2 operation.

Transition from the autonomous driving state to the manual driving state can also occur when the vehicle is currently being operated in Level 2 in which few overrides/supervision is required to a situation in which more frequent overrides/supervision can be required of the driver. The vehicle 10 remains in a situation in which Level 2 eyes-on, hands-off, or hands-on, can continue to operate, but the vehicle 10 is approaching a situation in which the driver can be required to override or modify the behavior of the automated driving system 32, such as a junction or downtown area. For example, this transition can occur on a rural road where the vehicle is operating in hands-off or hands-on Level 2, and a known junction (determined by the NAV 36), such as a light, stop sign, yield or merge, is upcoming on the travel course of the vehicle. Although the vehicle 10 can continue to operate in Level 2, the junction can require the driver to intervene. The transition can also occur when the vehicle 10 is entering a town in which there are a plurality of signed junctions from a rural road in which hands-off or hands-on Level 2 has been in use and there have been no stop or yield junctions for several miles. Another example of this transition is when the vehicle 10 is operated in hands-off or hands-on Level 2 on a rural road and a known speed limit change is coming up (determined by the NAV 36) and the driver should request a new speed setting the automated driving system 34.

The control system 32 includes a handover request module 60 and the capability module 56, as shown in FIG. 5. The handover request module 60 and the capability module 56 are configured to generate a request to the driver that the driver take control or be prepared to take control of one or more driving functions based on the upcoming driving scenario determined by the automated driving system 34. The tasks presented to the driver vary based on whether the automated driving system 34 determines whether a shared control request or a complete handover request is being presented to the driver. In the absence of the capability module 56, all handover requests transition from an existing level of automation to no automation, such that the driver must be prepared to perform all driving functions.

When the control system 32 includes the capability module 56, a partial handover directed to shared control is available. The activity module 52 transmits the generated prioritized list to tasks to the capability module 56 before transmitting the prioritized list to the engagement generation module 54, as shown in FIG. 5. The capability module 56 is programmed to identify which driving functions the driver is responsible for after the transition to a partial manual control. The activity module 52 eliminates activities from the prioritized list that the automated driving system 34 will retain control over after the transition. For example, when the vehicle transitions from a Level 3 to a hands-off Level 2, the driver is only required to monitor the driving scene and does not control the vehicle. Any activities on the prioritized list directed to controlling the vehicle are either removed from the prioritized list or assigned a lower priority before the prioritized list is transmitted to the engagement generation module 54.

The capability module 56 is further configured to identify whether the automated driving system 34 is likely to require a future transition and to generate specific tasks to ensure the driver is capable to take over appropriately. For example, the vehicle is traveling to an area in which hands-off Level 2 control needs to quickly transition to hands-on Level 2. The capability module 56 transmits a handover request to the activity module 52, which identifies upcoming activities required of the driver. The capability module 56 removes or lowers a priority of tasks to be presented to the driver that are not directed to vehicle control, thereby assessing the ability of the driver to assume hands-on Level 2 control when required.

The control system 32 further includes a driver monitor module 62, as shown in FIG. 5, configured to monitor the driver for distraction and/or incapacitation, as described above, with the internal sensors 14. The driver monitor module 62 receives information from the internal sensors 14, such as a camera, a microphone, and/or bio-sensors. The bio-sensors can determine heart rate and galvanic skin response, as well as other biological features of the driver. For example, the driver monitor module 62 determines whether the driver is asleep or falling asleep, such that the driver is unable to assume manual control of the vehicle. The driver monitor module 62 transmits a signal to the safety monitor module 58 when the driver monitor module 62 determines that the driver is unable to assume control, such that the safety monitor module 58 can request the automated driving system 34 bring the vehicle to a safe stop. The driver monitor module 62 prevents the transition from continuing when the driver is determined to be incapable or assuming the required level of control of the vehicle.

The control system 32 can further include a burden module 50 that receives information from the internal sensors 14. The burden module 50 determines a level of stress and activity of the driver to determine an overall burden of the driver, as described above. The burden module 50 is further configured to determine an activity that the driver has difficulty with based on the determined burden level and an activity type, such as where the driver is looking.

The burden module 50 is further configured to modify the tasks presented to the driver by the engagement generation module 54, as shown in FIG. 5. The burden module 50 modifies the presented tasks in accordance with a determined real-time state of the driver. For example, when the driver is determined to be distracted, the burden module 50 extends the timeline for the transition, if possible. When the driver is determined to be overburdened during the transition, the number of tasks presented to the driver is reduced to prevent overburdening the driver on the condition that the driver responds properly to the presented tasks. When the driver is determined to be very aware and is responding properly to the presented tasks, the number of tasks presented to the driver is reduced to prevent annoying the driver. When the driver appears to be tracking a vehicle in front of the vehicle 10 and this task is assigned a high priority for the upcoming situation and the timeframe is limited, this task is assigned a lower priority as the driver is already determined to be adequately performing this task, thereby allowing other tasks to be assigned a higher priority to increase the awareness of the driver. When the driver fails to response to a presented task, and the driver monitor module 62 and the burden model module 50 determine that the driver did not look in the appropriate direction required to respond to the presented task, the engagement generation module 54 presents a new task to the driver to address the specific region in which the driver should have looked to increase the awareness level of the driver.

The control system 32 further includes the safety monitor module 58, as shown in FIG. 5. The safety monitor module 58 receives information from the driver monitor module 62 and information from the engagement generation module 54 to determine whether the driver can assume the required control of the vehicle associated with the transition to the manual control state. The driver responds to the tasks presented by the engagement generation module 54 through the human interface module 30, which is part of the display device 22. When the safety monitor module 58 determines that the driver is not able to assume the required level of control, or when the driver is determined to operate the vehicle poorly following the transition to the manual control state, the safety monitor module 58 transmits a request to the automated driving system 34 to prevent the transition to the manual control state and/or to bring the vehicle to a safe stop.

The control system 32 further includes a user preferences module 66, as shown in FIG. 5. The preferences module 66 is configured to allow the driver to customize aspects of the control system 32, such as how the control system 32 interacts with the driver. For example, the font sizes associated with displayed tasks can be set to a size easily readable by the driver. The sound volume associated with a task presented audibly to the driver can be set to a desired level. The driver can set whether the task is presented audibly or visually. The preferences module 66 allows the driver to account for needs of the driver, such as color blindness, an experience level of the driver, and/or a notification level desired by the driver.

The control system 32 is also configured to learn and update through operation of the control system 32. The engagement generation module 54 can include tasks having uncertain answers in addition to the tasks presented having known answers. For example, the engagement generation module 54 can present the following tasks to the driver: how many vehicles are ahead in the present lane, which is a known answer, how many vehicles are ahead in the adjacent lane to the right, which is a known answer, and how many pedestrians are on the near crosswalk, which is an unknown answer. When the driver correctly answers the first two presented tasks, the control system 32 operations under an assumption that the answer to the unknown task is also correct. This information is then used to teach the on-board sensor network 12 to better interpret the data collected by the sensors of the on-board sensor network 12. When the task with the unknown answer is presented to the driver, the vehicle transmits data input by the driver responsive to the task to a remote server, as shown in FIG. 3, such as the number of pedestrians identified in the crosswalk. Sensor data captured by a vehicle sensor associated with the at least one task is transmitted to the remote server, such as an image of the crosswalk captured by a camera. The analysis of the sensor data captured by the vehicle sensor is updated based on the response data input by the driver.

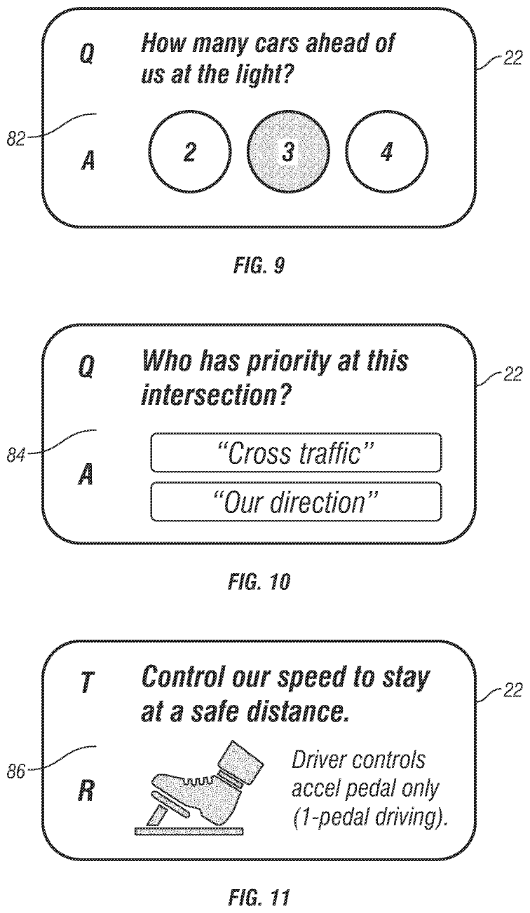

An exemplary operation of the control system 32 is described with reference to FIGS. 8-11. Based on the annotated maps stored in the map module 40, the control system 32 determines that the vehicle 10 is currently traveling in an area mapped as a Level 4 Geofenced Zone 68, as illustrated in FIG. 8. The Level 4 Geofenced Zone 68 is indicated by cross-hatching on the map of FIG. 8. The control system 32 identifies a transition point 70 at which the navigation route 72 the vehicle 10 is traveling exits the Level 4 Geofenced Zone 68. The transition point 70 is the point at which control is transitioned from the autonomous control state associated with the Level 4 Geofenced Zone 68 to the Level 0 control state outside the Level 4 Geofenced Zone. A control graph 74 illustrates a portion 76 of the navigation route 72 under the autonomous control state, a portion 78 of the navigation route 72 under the manual control state, and a transition portion 80 in which control transitions from the autonomous control state to the manual control state. As shown in Step S10 of FIG. 13, transitioning of vehicle control from the autonomous control state to the manual control state is determined.

The situation prediction module 46 identifies the upcoming scenario in which control is transitioned form the autonomous control state to the manual control state at the transition point 70. The activity module 52 generates a prioritized list of tasks, including an associated timeline, that is transmitted to the engagement generation module 54. The activity module 52 can interact with the capability module 56 to determine whether any tasks should be removed or assigned a different priority prior to transmitting the prioritized list to the engagement generation module 54. The engagement generation module 54 sequentially presents each of the tasks from the prioritized list to the driver.

As shown in FIGS. 6 and 9-11, three tasks are presented to the driver from the engagement generation module 54 through the human interfaces module 30. As shown in Step S20 of FIG. 13, at least one task, i.e., a query or an action, is presented to the driver. The interfaces module 30 presents the tasks to the driver though the display device 22 (FIG. 2), such as through the in-vehicle infotainment system. The first task 82 presented to the driver is a query requiring a visual inspection by the driver regarding how many cars are ahead of the vehicle at the light 102. The first task 82 is based on a current environment external of the vehicle 10. The first task 82 can be presented visually or audibly to the driver based on preferences set through the preferences module 66. The driver responds to the task through the in-vehicle infotainment system of the display device 22. The driver can touch a button on a touch screen corresponding to the number of vehicles the driver sees ahead at the light. Alternatively, the driver can respond to the query with an audible response.

The second task is another query directed to whether cross-traffic 104 or our direction has priority at the intersection 106. The driver can respond through the touch screen of the display device 22 or respond audibly.

The third task 86 presented to the driver is a task requiring operation of the vehicle by the driver. The third task 86 directs the driver to control the speed of the vehicle 10 to maintain a safe distance from a vehicle 108 ahead in the same lane. The operation of the vehicle by the driver responsive to the third task 86 is compared to how the vehicle would be controlled under autonomous control to determine preparedness of the driver.

The first task 82, the second task 84, and the third task 86 are presented to the driver during the transition period 80, as shown in FIG. 8. The engagement generation module 54 analyzes the responses from the driver to determine whether control of the vehicle can transition from the autonomous control state to the manual control state. As shown in Step S30 of FIG. 13, the engagement generation module 54 determines the driver response to the presented tasks. When the engagement generation module 54 determines that the driver is prepared based on the responses to the presented tasks, the vehicle control is transitioned from the autonomous control state to the manual control state, as shown in Step S40 of FIG. 13. When the engagement generation module 54 determines that the driver is not prepared based on the responses to the presented tasks, the vehicle control is prevented from transitioning from the autonomous control state to the manual control state, as shown in Step S50 of FIG. 13.

Another example, the automated driving system 34 is operating in a Level 2 mode in a low-complexity environment, such as on a highway. The automated driving system 34 determines that the Level 2 mode of operation will not be possible soon because the vehicle is about to enter a higher-complexity environment based on a programmed travel route of the vehicle. For example, the vehicle could be following a travel path taking an exit ramp off the highway and ending on a city street, as shown in FIG. 7. The driver is assumed to be paying some attention under the Level 2 mode of operation, but may not be paying sufficient attention required for operation of the vehicle under a Level 1 or 0 mode of operation because vehicle assistance from the automated driving system 34 is decreasing as the driving scene changes.

The control system 32 identifies with the situation prediction module 46 (FIG. 2) that a series of one or more situations, or scenarios, are upcoming. For example, the exit ramp from the highway and a busy multi-lane intersection 98 with traffic lights 100, as shown in FIG. 7. The activity module 56 of the control system 32 identifies tasks associated with these scenarios. The activity module 46 identifies tasks to be accomplished prior to the control transition including, but not limited to, identifying a location of the exit ramp, estimating a curvature of the exit ramp, slowing the vehicle to travel the exit ramp, selecting a lane on the exit ramp, determining a state of the traffic light at the intersection, identifying traffic at the intersection 98, and identifying pedestrians and/or bicyclists at the intersection.

The human interface 30 of the control system 32 generates a warning to the driver that Level 2 operation is becoming unavailable. The engagement generation module 54, in combination with the burden module 50, generates at least one task to be presented to the driver during the transition period (80 of FIG. 4) to ensure the driver is prepared to resume control of the vehicle.

When the vehicle is currently operating in an eyes-on, hands-off Level 2 operation mode, an important task is estimating a road curvature and controlling the wheel and pedals. In other words, the presented task is associates with hands-on control because the driver is currently operating in an eyes-on mode. The engagement generation module 54 presents a task to the driver to control the steering wheel and pedals to modify the action of the vehicle. The automated driving system 34 can enter the curve of the exit ramp in a sub-optimal mode, such as slightly too slow and slightly too tight a turn, or slightly too fast and slightly too wide a turn, that is within a safe operating envelope. The engagement generation module 54 monitors the operation of the steering wheel and pedals to determine whether the driver appropriately corrected the sub-optimal handling of the turn. When the driver is determined to have corrected the turn properly, the control system 32 transitions the vehicle from the autonomous control state to the manual control state. When the driver is determined to not have corrected the turn properly, the control system prevents transition from the autonomous control state to the manual control state.

When the burden module 50 is not available, the tasks presented to the driver are based on a priority assigned by the activity module 52, without reference to a current state of the driver. In this situation, priority can be assigned to identifying a state of the traffic light 100 and identifying the presence of pedestrians and/or cyclists at the intersection 98, as shown in FIG. 7. The engagement generation module 54 presents the driver with a first task in which a query is presented regarding the state of the traffic light 100. The second task is a prompt to scan for and indicate how many pedestrians and cyclists are present at the intersection 98. The driver monitor 66 can track eye movement of the driver responsive to the query to determine preparedness of the driver. The control system 32 compares the responses from the driver to the information detected by the sensors of the on-board sensor network 12 to determine whether the driver is prepared to take manual control of the vehicle.

In another example, the automated driving system 34 is operating in either a Level 3 or Level 4 mode. In accordance with operation in a Level 3 or Level 4 mode, the driver is not assumed to be paying attention, such that a greater burden exists to return the driver to a proper situational awareness to control the vehicle. The transition can be to either a Level 1 or Level 2 mode in which limited automated assistance (i.e., partially manual) is available or to a Level 0 mode that is fully manual.

The situation predictor 46 identifies any upcoming situations that occur after the transition out of the Level 3 or Level 4 mode. The activity model 52 identifies any activities that need to be accomplished by the driver to safely handle operation of the vehicle in the identified upcoming situations. The control system 32 provides a warning to the driver that the mode transition is occurring soon. The engagement generation module 54 generates a prioritized list of tasks to be accomplished by the driver during the transition period 80 (FIG. 4). The prioritized list can be modified in accordance with information from the burden module 50 and/or the capability module 56.

The vehicle 10 is exiting a highway via an exit ramp onto busy city streets, as shown in FIG. 6. The control system 32 presents at least one task to the driver a predetermined time in advance of the transition point. The predetermined time can be any suitable time period as determined by the control system 32, such as one minute. The following tasks can be presented to the driver, and the responses provided by the driver are monitored to determine whether the driver is prepared to assume control of the vehicle.

The driver can be prompted to identify which of a set of diagrams matches the traffic situation around the vehicle. This task prompts the user to visually scan for other vehicles and to develop spatial awareness. The internal sensors 14 track eye movement of the driver responsive to the query to determine preparedness of the driver. For example, the internal sensors 14 track whether the driver fully checked the traffic situation around the vehicle and did not limit the visual scan to only the driver side of the vehicle.

The driver can be prompted to identify the content of road signs. This task prompts the driver to look for and interpret signage.

The driver can be prompted to determine how far away the exit ramp is. This task prompts the user to develop spatial awareness.

The driver can be prompted to determine if the vehicle is in the proper lane to take the exit ramp. This task prompts the user to increase their situational awareness.

When a lane change is required, the driver can be prompted to take control of the steering wheel and to guide the vehicle into the proper lane to take the exit ramp, while all other automated driving system functions remain active. This task prompts the driver to increase their sensorimotor awareness of the vehicle.

The driver can be prompted to press the brake pedal to decrease a speed of the vehicle to a desired speed on the exit ramp. This task prompts the driver to increase their sensorimotor awareness of the vehicle.

The responses to the tasks presented to the driver by the engagement generation module 54 are monitored to determine whether the vehicle transitions to the manual control state or whether transition to the manual control state is prevented.

When the vehicle control transitions to a partially manual control state, i.e., a control state in which some automated driving features remain active after the transition, the tasks presented to the driver are modified accordingly. For example, lateral and longitudinal control tasks are omitted for transition from the Level 4 mode to the Level 2 mode where the driver is eyes-on, hands off. The presented tasks focus on identifying aspects of the environment surrounding the vehicle that the driver monitors in a hands-off Level 2 operational mode, such as monitoring traffic, pedestrian hazards, a travel route and path. The hands-off Level 2 does not require the driver to operate the steering wheel such that tasks directed to longitudinal and lateral control of the vehicle can be omitted.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the system and method of transitioning vehicle control. Accordingly, these terms, as utilized to describe the present invention should be interpreted relative to a vehicle equipped with the system and method of transitioning vehicle control.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A method of transitioning control of a vehicle from an autonomous control state to a manual control state, the method comprising:
determining a transition point at which control of the vehicle changes from the autonomous control state to the manual control state;
presenting at least one task to a driver in advance of the transition point;
determining whether the response of the driver to the at least one task indicates preparedness of the driver;
transitioning control of the vehicle from the autonomous control state to the manual control state when the driver is determined to be prepared; and
preventing the transition from the autonomous control state to the manual control state when the driver is determined to not be prepared.

2. The method of transitioning control according to claim 1, wherein
the manual control state is a fully manual control state.

3. The method of transitioning control according to claim 1, wherein
the manual control state is a partially manual control state.

4. The method of transitioning control according to claim 1, wherein
the transition point is determined based on the autonomous control state not being available.

5. The method of transitioning control according to claim 1, wherein
the at least one task presented is based on a current environment external of the vehicle.

6. The method of transitioning control according to claim 1, wherein
the at least one task presented to the driver is a query requiring a visual inspection by the driver, and
eye movement of the driver responsive to the query is tracked to determine preparedness of the driver.

7. The method of transitioning control according to claim 1, wherein
the at least one task presented to the driver is a query; and
the query is responded to through a display device of the vehicle.

8. The method of transitioning control according to claim 7, further comprising
responding to the query with an audible response.

9. The method of transitioning control according to claim 1, wherein
the at least one task presented to the driver is a task requiring operation of the vehicle by the driver; and
the operation of the vehicle by the driver responsive to the task is compared to an autonomous control for the task under an autonomous control state to determine preparedness of the driver.

10. The method of transitioning control according to claim 1, further comprising
determining an amount of time for the vehicle to reach the transition point.

11. The method of transitioning control according to claim 10, wherein
the at least one task presented to the driver is based on the amount of time determined to reach the transition point.

12. The method of transitioning control according to claim 1, wherein
the least one task is based on whether the vehicle is transitioning to a fully manual control state or to a partially manual control state.

13. The method of transitioning control according to claim 1, further comprising
upon presenting the at least one task to the driver,
transmitting response data input by the driver responsive to the least one task to a remote server,
transmitting sensor data captured by a vehicle sensor associated with the at least one task to the remote server, and
updating the analysis of the sensor data captured by the vehicle sensor based on the response data input by the driver.

14. A vehicle control system to transition control of a vehicle from an autonomous control state to a manual control state, the control system comprising:
an on-board satellite navigation system in communication with a global positioning system;
an on-board sensor network configured to monitor conditions internally and externally of the vehicle;
a display device; and
a processor configured to
determine a transition point at which control of the vehicle changes from the autonomous control state to the manual control state;
present at least one task to a driver in advance of the transition point through the display device based on information obtained by the on-board satellite navigation system and the on-board sensor network;
determine whether the response of the driver to the at least one task indicates preparedness of the driver;
transition control of the vehicle from the autonomous control state to the manual control state when the driver is determined to be prepared; and
prevent the transition from the autonomous control state to the manual control state when the driver is determined to not be prepared.

15. The vehicle control system according to claim 14, wherein
the processor is further configured to determine an amount of time for the vehicle to reach the transition point.

16. The vehicle control system according to claim 15, wherein
the at least one task presented to the driver is based on the amount of time determined to reach the transition point.

17. The vehicle control system according to claim 14, wherein
the on-board sensor network includes at least one internal camera positioned to detect behavior of the driver responsive to the at least one task.

18. The vehicle control system according to claim 14, wherein
the at least one task presented to the driver is based on a current environment external of the vehicle detected by the on-board sensor network.

19. The vehicle control system according to claim 14, wherein
the display device includes at least one of a display screen and a speaker configured to present the at least one task to the driver.

20. The vehicle control system according to claim 14, wherein
the at least one task presented to the driver is based on information input by the driver through the display device.
